(19) United States
(12) Patent Application Publication
(10) Pub. No.: US 2025/0219540 A1
(43) Pub. Date: Jul. 3, 2025

(54) FREQUENCY REGULATION CIRCUIT, REGULATION METHOD FOR SWITCHING POWER SUPPLY AND SWITCHING POWER SUPPLY

(71) Applicant: Joulwatt Technology Co., Ltd., Hangzhou (CN)

(72) Inventor: Sio Pang CHAN, Hangzhou (CN)

(21) Appl. No.: 19/008,578

(22) Filed: Jan. 2, 2025

(30) Foreign Application Priority Data
Jan. 3, 2024 (CN) 202410014318.9

(51) Int. Cl. H02M 3/158

(52) U.S. Cl. CPC H02M 3/158

(57) ABSTRACT

The present application discloses a frequency regulation circuit and a regulation method for a switching power supply, and a switching power supply. By the regulation of a light load regulation circuit, in the discontinuous working mode, when the main power transistor and the freewheeling transistor are both turned off for a time exceeding a preset time, the freewheeling transistor is turned on to increase system frequency and system noise is reduced; moreover, the on time of the freewheeling transistor is regulated by the feedback of the output voltage, resulting in stable system frequency, stable output voltage, and low system loss.

### CROSS-REFERENCE TO RELATED APPLICATIONS

This present disclosure claims priority to a Chinese patent application No. 2024100143189, filed on Jan. 3, 2024, and entitled “frequency regulation circuit, regulation method for switching power supply and switching power supply”, the entire contents of which are incorporated herein by reference, including the specification, claims, drawings and abstract.

### FIELD

The present disclosure relates to the field of switching power supply control technology, more specifically, to a frequency regulation circuit, a regulation method for a switching power supply, and a switching power supply.

### BACKGROUND

As a common power conversion circuit, switch power supplies are used to convert input voltage into output voltage. Common switch power supplies, such as Buck switching power supply, which includes a main power transistor and a freewheeling transistor, which are turned on and off alternatively to output stable output voltage. Under light load conditions, the power transistor of the switching power supply (including a main power transistor and other power transistors, such as a freewheeling transistor) is turned off, so that the switching power supply enters a discontinuous operation mode, until the controller sends another conduction pulse of the main power transistor, and enters the next switch cycle.

In the discontinuous working mode, if the off time of the main power transistor and the freewheeling transistor is long, it will cause the system frequency to be very low and generate noise.

Therefore, it is necessary to provide improved technical solutions to overcome the above-mentioned technical problems in the current technologies.

### SUMMARY

In view of this, the purpose of the present disclosure is to provide a frequency regulation circuit and a regulation method for a switching power supply and a switching power supply, to resolve the technical problem of noise caused by low frequency of switch power supplies under light load conditions in the current technologies.

A frequency regulation circuit for a switching power supply is provided, and the switching power supply comprises a main power transistor and a freewheeling transistor, wherein comprising a switch signal circuit and a light load control circuit; the switch signal circuit generates a switch control signal to control the on/off of the main power transistor and the freewheeling transistor; the light load control circuit is connected to the switch signal circuit, and starts timing after detecting that both the main power transistor and the freewheeling transistor are turned off; when the timing time reaches a preset first time, an on signal is generated to control the freewheeling transistor to turn on; the light load control circuit receives the output feedback signal of the switching power supply and controls a conduction duration of the freewheeling transistor accordingly.

Optionally, under light load conditions, the switch signal circuit controls both the main power transistor and the freewheeling transistor to turn off.

Optionally, the duration of the preset first time is set to indicate that the working frequency of the switching power supply reaches the frequency lower limit.

Optionally, the light load control circuit generates an off signal to control the freewheeling transistor to turn off when the conduction of the freewheeling transistor reaches the conduction duration, and generates an on signal of the main power transistor to control the main power transistor to turn on.

Optionally, the light load control circuit comprises a timing circuit; the timing circuit receives the switch control signals of the main power transistor and the freewheeling transistor; when the switch control signal indicates that both the main power transistor and the freewheeling transistor are turned off, the timing circuit starts timing; when the timing time reaches the preset first time, an on signal for the freewheeling transistor is generated.

Optionally, the light load control circuit further comprises a conduction duration control circuit; the conduction duration control circuit receives the output feedback signal of the switching power supply and obtains a first reference current based on it; when the inductor current sampling signal of the switching power supply reaches the first reference current, it controls the freewheeling transistor to turn off.

Optionally, the conduction duration control circuit receives the output feedback signal of the switching power supply and the output reference signal to obtain an error compensation signal, and error amplification is performed on the error compensation signal and the first reference signal to obtain the first reference current; the conduction duration control circuit receives the inductor current sampling signal from the switching power supply and compares the inductor current sampling signal with the first reference current, and when the inductor current sampling signal reaches the first reference current, it generates an off signal to control the freewheeling transistor to turn off.

Optionally, the light load control circuit comprises a conduction duration control circuit; the conduction duration control circuit receives the output feedback signal of the switching power supply and the output reference signal to obtain a first parameter representing the difference between the two, adjusts the preset conduction duration according to the first parameter, and controls the freewheeling transistor to turn off when the conduction duration of the freewheeling transistor reaches the preset conduction duration.

Optionally, the conduction duration control circuit receives the output feedback signal of the switching power supply and the output reference signal, and compares the two to obtain a comparison signal; the comparison signal is processed by analog-to-digital conversion to obtain a first parameter representing the difference between the two; the first parameter adjusts a pulse width of the preset pulse signal to adjust the preset conduction duration, wherein the pulse width of the pulse signal represents the conduction duration.

Optionally, the conduction duration control circuit receives the output feedback signal of the switching power supply and the output reference signal, and performs error compensation processing on the two to obtain a compensation signal; the conduction duration control circuit sets the pulse width of the pulse signal to be positively correlated with the compensation signal to adjust the preset conduction duration, wherein the pulse width of the pulse signal represents the conduction duration.

In a second aspect, a frequency regulation method for a switching power supply, the switching power supply comprising a main power transistor and a freewheeling transistor, wherein comprising steps of: starting timing after detecting that both the main power transistor and the freewheeling transistor are turned off, and generating an on signal to control the freewheeling transistor to turn on when the timing time reaches the preset first time; controlling the conduction duration of the freewheeling transistor according to the output feedback signal of the switching power supply, and turning off the freewheeling transistor when the conduction of the freewheeling transistor reaches the conduction duration, and turning on the main power transistor after turning off the freewheeling transistor.

Optionally, both the main power transistor and the freewheeling transistor are controlled to turn off under light load conditions.

Optionally, both the main power transistor and the freewheeling transistor are controlled to turn off under light load conditions.

In a third aspect, a switching power supply is provided, which comprises a main power transistor and a freewheeling transistor, wherein it further comprises the above frequency regulation circuit for the switching power supply, and the frequency regulation circuit controls the switching actions of the main power switch and the freewheeling transistor to regulate the working frequency of the switching power supply.

By using the frequency regulation circuit and the switching power supply of the present disclosure, and by the regulation of the light load regulation circuit, in the discontinuous working mode, when the main power transistor and the freewheeling transistor are both turned off for a time exceeding the preset time, the freewheeling transistor is turned on, thereby increasing the system frequency and reducing system noise; moreover, the feedback of the output voltage is used to regulate the on time of the freewheeling transistor, resulting in stable system frequency, stable output voltage, and low system loss.

### BRIEF DESCRIPTION OF THE DRAWINGS

FIG. 1 is a circuit block diagram of the control circuit of switching power supply according to the present disclosure;

FIG. 2 is a first circuit block diagram of the light load regulation circuit in FIG. 1;

FIG. 3 is a first implementing circuit diagram of the light load regulation circuit in FIG. 2 according to the present disclosure;

FIG. 4 is a second circuit block diagram of the light load regulation circuit of FIG. 1;

FIG. 5 is a first implementing circuit diagram of the light load regulation circuit in FIG. 4 according to the present disclosure;

FIG. 6 is a second implementing circuit diagram of the light load regulation circuit in FIG. 4 according to the present disclosure;

FIG. 7 is a working waveform of the circuit diagram of FIG. 3.

### DETAILED DESCRIPTION

The following will describe the preferred embodiments of the present disclosure in great details by combining with the accompanying drawings. However, the present disclosure is not restricted to these embodiments. The present disclosure convers any replacement, modifications, equivalent methods, and solutions made within the sprits and scope of the present disclosure.

In order to make the public have a thorough understanding, specific details are described in the following preferred embodiments of the present disclosure; however, those skilled in the art can totally understand the present disclosure without these detailed descriptions.

The present disclosure is described in great details in the following paragraphs by referring to the accompanying drawings. It should be noted that the accompanying drawings all use simplified forms and use non-accurate sales, just for the purpose of conveniently and clearly illustrate the embodiments of the present disclosure.

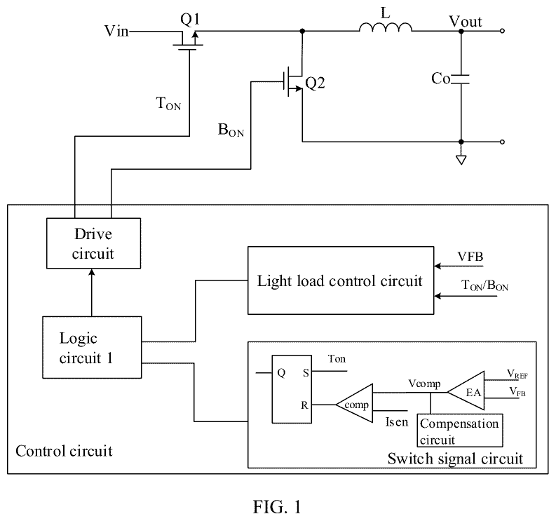

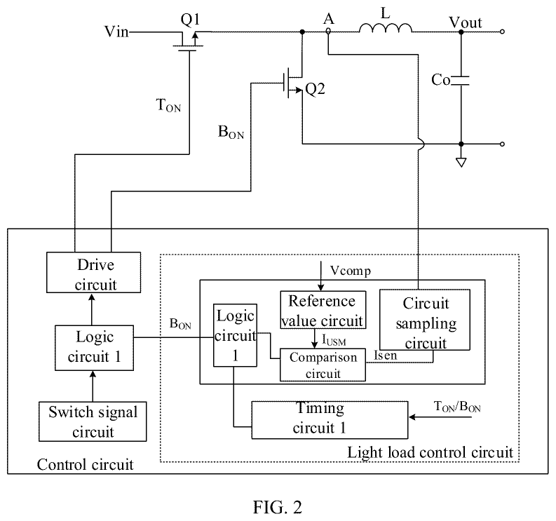

Refer to FIG. 1, it is a circuit diagram of a control circuit of the switching power supply according to the present disclosure. FIG. 2 is a first circuit diagram of the light load regulation circuit of FIG. 1. The control circuit of the switching power supply includes a frequency control circuit, a logic circuit 1, and a driving circuit. The control circuit controls the main power transistor Q1 and the freewheeling transistor Q2 to alternatively turn on and off to convert the input voltage Vin into a predetermined output voltage Vout for output. Here, logic circuit 1 and the driving circuit can be of existing circuit structures. The logic circuit can be an RS flip-flop, and the driving circuit may be an upper and lower driving current circuit composed of transistors. In this example, the frequency regulation circuit comprises a switch signal circuit and a light load control circuit. Under normal load conditions, the switch signal circuit of the control circuit generates switch signals to control the switching actions of the main power transistor Q1 and the freewheeling transistor Q2. One way to implement the switch signal circuit is: amplifying and compensating for the error between the output voltage feedback signal V_{FB} and the output reference signal V_{REF} to obtain a compensation signal Vcomp. After comparing the compensation signal Vcomp with the inductor current sampling signal Isen of the switching power supply, a signal is obtained to control the main power transistor Q1 to turn off. The turning-on of the main power transistor Q1 can be controlled by a fixed time circuit. For example, if the main power transistor Q1 is turned off for a fixed time Ton, a trigger signal is obtained to control the turning-on of the main power transistor Q1.

When the system load enters the light load state, due to the decrease in output power, the system will enter the discontinuous working mode, that is, the main power transistor Q1 and the freewheeling transistor Q2 will both enter an off state after completing the turning-on and -off action. When the load power is at an extremely light load, the off time of the main power transistor Q1 and the freewheeling transistor Q2 is long, and the system will enter an extremely low working frequency, causing significant noise in the system. In this application, system working frequency is prevent from being too low by setting a preset duration. In this application, both the main power transistor Q1 and the freewheeling transistor Q2 are turned off, and the light load control circuit starts timing. When the timing time reaches the preset time, the freewheeling transistor Q2 is controlled to turn on. Then, based on the output voltage feedback signal, the duration of the freewheeling transistor Q2 is controlled, and an off signal of the freewheeling transistor Q2 is generated to control the turning-off of the freewheeling transistor Q2, and an on signal of the main power transistor Q1 is generated to turn on the main power switch Q1. Here, the duration of the preset first time is set when the working frequency of the switching power supply reaches the frequency lower limit. The frequency lower limit here is set as the lowest value of the system operating frequency. That is, when the working frequency of the switching power supply reaches the lower limit, the freewheeling transistor is turned on to increase the system working frequency.

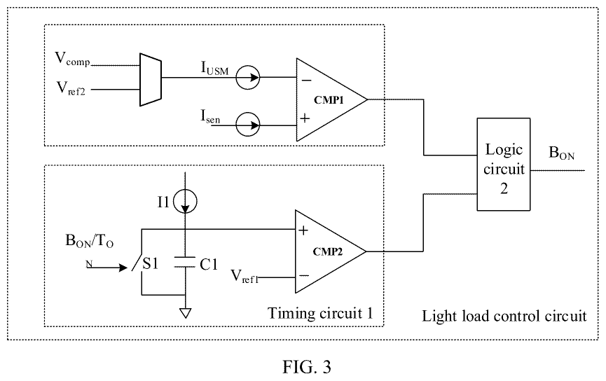

FIG. 2 is a first circuit diagram of the light load regulation circuit of FIG. 1, and FIG. 3 is a first implementation circuit diagram of the light load control circuit in FIG. 2 of the present disclosure; in the schematic diagrams of FIGS. 2 and 3, the light load control circuit comprises a timing circuit that receives switch control signals from the main power transistor and the freewheeling transistor, such as T_{ON} and B_{ON}. When the switch control signal indicates that both the main power transistor and the freewheeling transistor are turned off, the timing circuit starts timing. When the timing time reaches the preset first time, an on signal is generated to control the conduction of the freewheeling transistor. Specifically, the timing circuit comprises a current source I1, a switch S1, a capacitor C1, and a comparator CMP2. When the switch control signals T_{ON} and B_{ON} are both low, switch S1 is turned off, the current source I1 charges the capacitor C1, and one input end of the comparator CMP2 receives the charging voltage of the capacitor C1, and the other input end receives the first reference signal Vref. When the charging voltage of the capacitor C1 reaches the first reference signal Vref, the output signal of the comparator becomes a high-level effective state to control the turning-on of the freewheeling transistor. Here, after switch S1 is turned off, the duration that the charging voltage of the capacitor C1 reaches the first reference signal Vref is the duration of the first time, and the magnitude of the first reference signal Vref is set that the system working frequency is no less than the minimum value, thus actively controlling the system working frequency.

Continue to refer to FIG. 3, the light load control circuit further comprises a conduction duration control circuit, which comprises a reference value circuit, a current sampling circuit, and a comparison circuit. The reference value circuit receives the output feedback signal of the switching power supply and obtains the first reference current I_{USM} based on it. The current sampling circuit obtains the inductor current sampling signal Isen, and the comparison circuit compares the inductor current sampling signal Isen with the first reference current I_{USM}. When the inductor current sampling signal Isen of the switching power supply reaches the first reference current I_{USM}, an on signal is generated to control the freewheeling transistor Q2 to turn off. Here, the current sampling signal can be an existing sampling circuit, and the inductor current sampling signal Isen and the first reference current I_{USM} can be voltage signals representing current information. Specifically, the reference value circuit comprises a transconductance amplifier that receives the error compensation signal Vcomp and the first reference signal Vref, amplifies the error to obtain the first reference current I_{USM}; the error compensation signal Vcomp is obtained by amplifying and compensating the error of the output feedback signal of the switching power supply and the output reference signal. The comparison circuit comprises a comparator CMP1, which compares the inductor current sampling signal with the first reference current. When the inductor current sampling signal reaches the first reference current, it generates an off signal to control the freewheeling transistor to turn off. The switch control signal B_{ON} of the freewheeling transistor Q2 comprises the on signal and off signal of the freewheeling transistor.

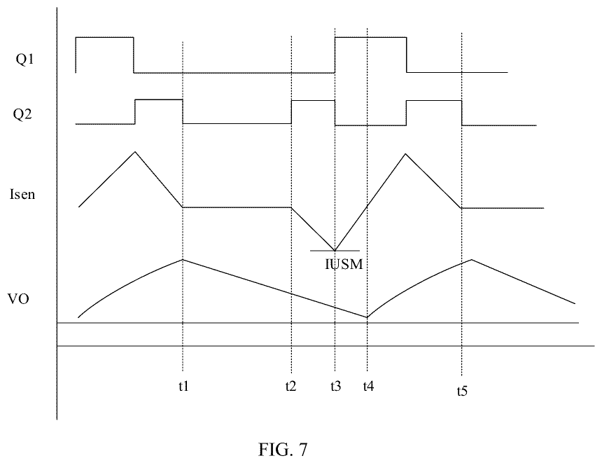

FIG. 7 shows a working waveform diagram of the circuit diagram in FIG. 3. At time t1, the switching power supply enters the discontinuous working mode, and both the main power transistor Q1 and the freewheeling transistor Q2 are turned off. The inductor current sampling signal Isen is zero, and the output voltage Vo begins to decrease. Then, when the frequency control circuit detects that the duration of both the main power transistor Q1 and the freewheeling transistor Q2 are turned off has reached the preset duration, i.e., the duration from t1 to t2, it generates a signal to control the turning-on of the freewheeling transistor Q2; at this point, the inductor current continues to decrease, the compensation signal Vcomp decreases, and the reference value circuit obtains the first reference current I_{USM}. When the inductor current sampling signal Isen reaches the first reference current I_{USM}, the freewheeling transistor Q2 is controlled to be turned off at time t3, and after dead time is elapsed, the main power transistor Q1 is controlled to be turned on. At time t4, the output voltage Vo begins to rise. From the above graph, it can be seen that at time t2, actively turning on the freewheeling transistor can control the regulation of system frequency, increase the system operation frequency, and the output voltage can be stable without being too high or too low.

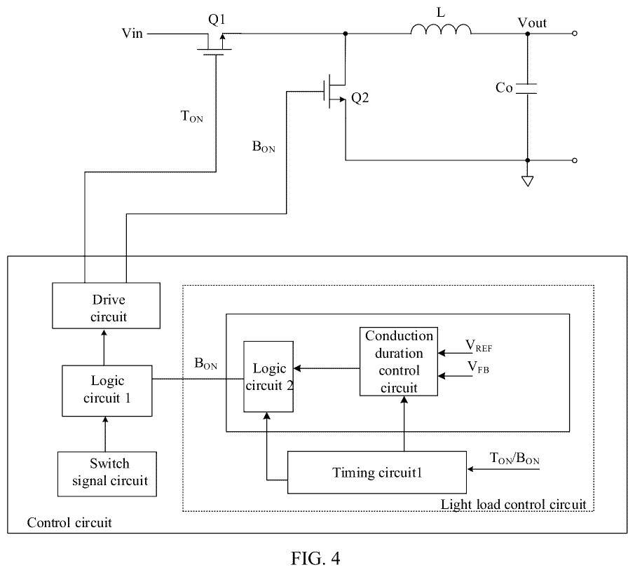

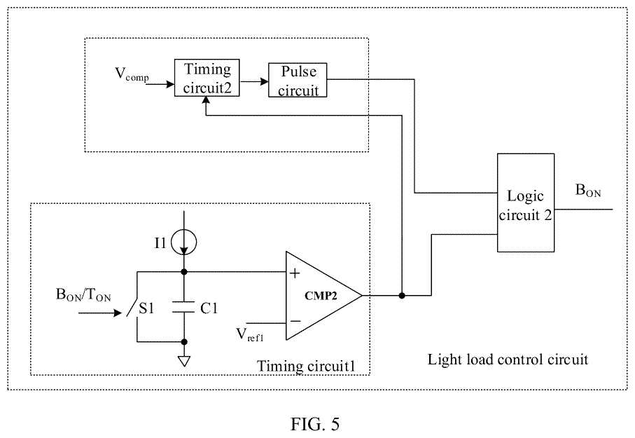

Refer to FIG. 4, it is a second circuit diagram of the light load regulation circuit in FIG. 1, and FIG. 5 is a first implementing circuit diagram of the light load regulation circuit in FIG. 4 of the present disclosure; the light load control circuit further comprises a conduction duration control circuit, which receives the output feedback signal of the switching power supply and the output reference signal, obtains a first parameter representing the difference between the two, adjusts the preset conduction duration according to the first parameter, and controls the turning-off of the freewheeling transistor when the on time of the freewheeling transistor reaches the preset conduction duration. Specifically, refer FIG. 5, the conduction duration control circuit receives the output feedback signal of the switching power supply and the output reference signal, and performs error compensation processing on the two to obtain the compensation signal Vcomp. The conduction duration control circuit can also obtain the compensation signal Vcomp from the switching signal circuit, with the compensation signal Vcomp as the first parameter. The conduction duration control circuit can set the pulse width of a pulse signal by the timing circuit 2, which represents the conduction duration. The timing circuit 2 receives the compensation signal Vcomp and regulates the pulse width of the pulse signal according to the compensation signal Vcomp, such as setting the pulse width of the pulse signal to be positively correlated with the compensation signal; in this way, when the output feedback signal changes, the compensation signal Vcomp follows the change, and the conduction duration changes accordingly, which can well regulate the conduction duration of the freewheeling transistor in a timely manner according to the output situation, thereby stabilizing the output voltage. After that, the pulse circuit obtains a pulse signal based on the triggering of the timing circuit to trigger the freewheeling transistor to turn off. The light load control circuit here further comprises logic circuit 2, which can be an RS flip-flop, and it generates a control signal based on the output signal of comparator CMP2 and the output signal of the pulse circuit to control the on/off of the freewheeling transistor.

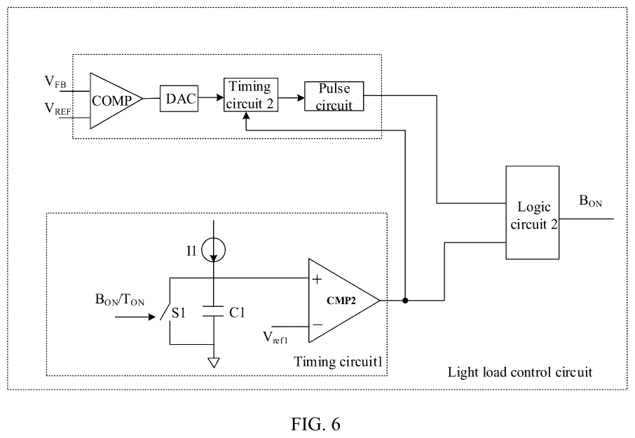

Refer to FIG. 6, it is a second implementation circuit diagram of the light load regulation circuit in FIG. 4 of the present disclosure; this embodiment is the same as the timing circuit 2 and the pulse circuit in the example of FIG. 5, except that the conduction duration control circuit here receives the output feedback signal of the switching power supply and the output reference signal, and compares the two to obtain a comparison signal, and obtains a first parameter representing the difference between the two after the analog-to-digital conversion processing. The first parameter adjusts the pulse width of the preset pulse signal to adjust the preset conduction duration, wherein the pulse width of the pulse signal represents the conduction duration, and the first parameter here can be the step data representing the comparison signal, so as to adjust the pulse width of the preset pulse signal based on the step data. Similarly, in this example, the conduction duration of the freewheeling transistor can also be regulated in a timely manner according to the output situation, thereby stabilizing the output voltage.

Finally, the present application also proposes a switching power supply comprising a main power transistor and a freewheeling transistor, and further comprising a frequency regulation circuit for the switching power supply, wherein the frequency regulation circuit controls the switching action of the main power transistor and the freewheeling transistor to adjust the working frequency of the switching power supply. The switching power supply described in this application can be a boost type switching power supply, a buck type switching power supply, or a buck/boost type switching power supply; the switching power supply of this application can solve the noise problem caused by the system at extreme low frequencies by actively turning on the freewheeling transistor to increase the system working frequency when the system working frequency drops to the limit under very light loads. Moreover, the output voltage can be well stabilized by controlling the on time of the freewheeling transistor by the outputting feedback signals.

It should be noted that the specific implementation and corresponding legends provided are merely one way to describe the implementation method of the present disclosure, rather than limiting the specific structure of the implementation scheme of the present disclosure. Various changes or modifications can be made to these implementation schemes without departing from the principles and essence of the present disclosure, but these changes and modifications all fall within the scope of protection of the present disclosure.

Although the embodiments have been explained and elaborated separately, some common technologies involved can be replaced and integrated among the embodiments in view of those of ordinary skill in the art. If there is any content that is not explicitly recorded in one embodiment, reference can be made to another embodiment that is recorded.

The above implementations do not constitute limitation on the protection scope of the technical solution. Any modifications, equivalent substitutions, and improvements made within the spirit and principles of the above implementation shall be included within the protection scope of the technical solutions.

What is claimed is:

1. A frequency regulation circuit for a switching power supply, the switching power supply comprising a main power transistor and a freewheeling transistor, wherein the frequency regulation circuit comprises a switch signal circuit and a light load control circuit,
the switch signal circuit generates a switch control signal to control the on and off of the main power transistor and the freewheeling transistor,
the light load control circuit is connected to the switch signal circuit, and starts timing after detecting that both the main power transistor and the freewheeling transistor are off; upon a timing time reaches a preset first time, an on signal is generated to control the freewheeling transistor to turn on;
the light load control circuit receives an output feedback signal of the switching power supply and controls a conduction duration of the freewheeling transistor.

2. The frequency regulation circuit for a switching power supply of claim 1, wherein
under light load, the switch signal circuit controls both the main power transistor and the freewheeling transistor to turn off.

3. The frequency regulation circuit for a switching power supply of claim 2, wherein
a duration of the preset first time is set to indicate that a working frequency of the switching power supply reaches a frequency lower limit.

4. The frequency regulation circuit for a switching power supply of claim 1, wherein
the light load control circuit generates an off signal to control the freewheeling transistor to turn off upon conducting the freewheeling transistor reaches a preset conduction duration, and generates an on signal of the main power transistor to control the main power transistor to turn on.

5. The frequency regulation circuit for a switching power supply of claim 1, wherein the light load control circuit comprises a timing circuit,
the timing circuit receives the switch control signals of the main power transistor and the freewheeling transistor; upon the switch control signal indicates that both the main power transistor and the freewheeling transistor are off, the timing circuit starts timing; upon the timing time reaches the preset first time, the on signal for the freewheeling transistor is generated.

6. The frequency regulation circuit for a switching power supply of claim 5, wherein the light load control circuit further comprises a conduction duration control circuit,
the conduction duration control circuit receives the output feedback signal of the switching power supply and obtains a first reference current based on the output feedback signal; upon an inductor current sampling signal of the switching power supply reaches the first reference current, the freewheeling transistor is controlled to turn off.

7. The frequency regulation circuit for a switching power supply of claim 6, wherein
the conduction duration control circuit receives the output feedback signal of the switching power supply and an output reference signal to obtain an error compensation signal, and performs error amplification on the error compensation signal and the first reference signal to obtain the first reference current;
the conduction duration control circuit receives the inductor current sampling signal of the switching power supply and compares the inductor current sampling signal with the first reference current, and generates an off signal to control the freewheeling transistor to turn off upon the inductor current sampling signal reaches the first reference current.

8. The frequency regulation circuit for a switching power supply of claim 5, wherein the light load control circuit further comprises a conduction duration control circuit,
the conduction duration control circuit receives the output feedback signal of the switching power supply and the output reference signal to obtain a first parameter representing a difference between the two, and adjusts a preset conduction duration according to the first parameter; upon the conduction duration of the freewheeling transistor reaches the preset conduction duration, the freewheeling transistor is controlled to turn off.

9. The frequency regulation circuit for a switching power supply of claim 8, wherein the conduction duration control circuit receives and compares the output feedback signal of the switching power supply and the output reference signal to obtain a comparison signal,
the comparison signal is processed by analog-to-digital conversion to obtain the first parameter representing the difference between the two,
the first parameter regulates a pulse width of a preset pulse signal to adjust the preset conduction duration, wherein the pulse width of the pulse signal represents the preset conduction duration.

10. The frequency regulation circuit for a switching power supply of claim 8, wherein
the conduction duration control circuit receives and performs error compensation processing on the output feedback signal of the switching power supply and the output reference signal to obtain a compensation signal,
the conduction duration control circuit sets a pulse width of a pulse signal to be positively correlated with the compensation signal to adjust the preset conduction duration, wherein the pulse width of the pulse signal represents the preset conduction duration.

11. A frequency regulation method for a switching power supply, the switching power supply comprising a main power transistor and a freewheeling transistor, wherein the frequency regulation method comprises:
starting timing after detecting that both the main power transistor and the freewheeling transistor are turned off, and generating an on signal to control the freewheeling transistor to turn on upon the timing time reaches a preset first time;
controlling a conduction duration of the freewheeling transistor according to an output feedback signal of the switching power supply, and turning off the freewheeling transistor upon the freewheeling transistor is conducted reaches a preset conduction duration; and
turning on the main power transistor after turning off the freewheeling transistor.

12. The frequency regulation method for a switching power supply of claim 11, wherein
controlling both the main power transistor and the freewheeling transistor to turn off under light load.

13. The frequency regulation method for a switching power supply of claim 12, wherein
a duration of the preset first time is set to indicate that a working frequency of the switching power supply reaches a frequency lower limit.

14. A switching power supply comprising a main power transistor, a freewheeling transistor, and the frequency regulation circuit for the switching power supply according to claim 1,
the frequency regulation circuit controls the on and off of the main power switch and the freewheeling transistor to regulate a working frequency of the switching power supply.
